(19) United States
(12) Patent Application Publication
(10) Pub. No.: US 2021/0012346 A1
(43) Pub. Date: Jan. 14, 2021

(54) RELATION-BASED SYSTEMS AND METHODS FOR FRAUD DETECTION AND EVALUATION

(71) Applicant: Capital One Services, LLC, McLean, VA (US)

(72) Inventors: Austin WALTERS, Savoy, IL (US); Jeremy GOODSITT, Champaign, IL (US); Fardin Abdi Taghi ABAD, Champaign, IL (US); Reza FARIVAR, Champaign, IL (US); Vincent PHAM, Champaign, IL (US); Kenneth TAYLOR, Champaign, IL (US); Mark WATSON, Sedona, AZ (US)

(21) Appl. No.: 16/507,147

(22) Filed: Jul. 10, 2019

(51) Int. Cl. G06Q 20/40; G06F 16/901

(52) U.S. Cl. CPC G06Q 20/4016; G06Q 20/20; G06F 16/9024

(57) ABSTRACT

A method for detecting fraud is provided in which a graph database of transaction relationships is constructed using transaction information for a plurality of transactions. Using the graph database, a plurality of account holder identifiers are associated into an account holder group. When transaction information for a new transaction associated with a transaction account holder identifier is received, a determination is made as to whether the transaction account holder identifier is in the account holder group. Responsive to a determination that the transaction account holder identifier is included in the account holder group, the new transaction information is compared to the transaction information for the account holder group and a fraud factor is determined for the new transaction. The fraud factor is indicative of a degree of similarity to the transaction information of the account holder group.

### FIELD OF THE INVENTION

This disclosure relates to account security and transaction verification, and more specifically, to systems and methods for account monitoring and transaction verification.

### BACKGROUND OF THE INVENTION

Financial companies typically use various methods to detect fraud in consumer financial transactions. In some cases, these may be based on historical usage patterns for individual consumers, which can be used to establish behavior departure and other predictive triggers. These could include larger than normal purchases, purchases made at a large distance from the consumer's home town, or purchases with other characteristics that could be indicative of a fraudulent transaction. When such a trigger is encountered, the transaction processor may be faced with the decision as to whether to notify the consumer of a potential concern or to place a hold on the transaction. However, while some aspects of a transaction may be sufficiently indicative of potential fraud to trigger a flag, most triggering events are authentic consumer transactions. To avoid unnecessary alerts or impacts on non-fraudulent transactions, it is highly desirable to use secondary factors and analysis to further assess the likelihood that a transaction is actually fraudulent.

### SUMMARY OF THE INVENTION

An illustrative aspect of the invention provides a fraud evaluation system comprising a server in data communication with a transaction database comprising transaction information for a plurality of transactions. The transaction information for each transaction includes an account holder identifier. The system further comprises an automated data processor in data communication with the server. The data processor is configured to construct a graph database of transaction relationships using the transaction information for the plurality of transactions. The data processor is further configured to associate a plurality of account holder identifiers into an account holder group using the graph database. Upon the addition to the transaction database of transaction information for a new transaction associated with an account holder in the account holder group, the data processor compares the new transaction information to the transaction information in the graph database for the account holder group. The data processor then determines for the new transaction information a fraud factor indicative of a degree of similarity to the transaction information of the account holder group.

Another aspect of the invention provides a method for detecting fraud comprising constructing a graph database of transaction relationships using transaction information for a plurality of transactions. The transaction information includes, for each transaction, an account holder identifier and at least one transaction parameter selected from the group consisting of a transaction location, a transaction time, a transaction vendor, a purchase type, and a purchase amount. The method further comprises associating a plurality of account holder identifiers into an account holder group using the graph database. The method still further comprises receiving transaction information for a new transaction associated with a transaction account holder identifier and determining whether the transaction account holder identifier is included in the account holder group. Responsive to a determination that the transaction account holder identifier is included in the account holder group, the new transaction information is compared to the transaction information in the graph database for the account holder group and a fraud factor is determined for the new transaction. The fraud factor is indicative of a degree of similarity to the transaction information of the account holder group.

Another aspect of the invention provides a transaction processing system. The system comprises a plurality of merchant transaction devices configured for conducting transactions with account holders, for transmitting transaction information for such transactions over a network, and for receiving transaction evaluation information over the network. The transaction information includes, for each transaction, an account holder identifier and at least one transaction parameter. The system further comprises an automated transaction data processing server configured for receiving transaction information from each of the plurality of merchant transaction devices via the network. The transaction data processing server is also configured for selectively processing the transaction and for transmitting transaction processing results to each of the plurality of merchant transaction devices. The system still further comprises a transaction database configured for receiving transaction information from the transaction data processing server and for storage of the transaction information for transactions associated with a plurality of account holders. The system also comprises an automated transaction monitoring server in data communication with the transaction data processing server. The transaction monitoring server is configured to receive transaction information for the plurality of transactions from the transaction data base and construct a graph database of transaction relationships using the transaction information for the plurality of transactions. The server is further configured to associate a plurality of account holder identifiers into an account holder group based on a statistical transaction similarity determined using the graph database. Upon the addition to the transaction database of transaction information received from one of the merchant transaction devices for a new transaction associated with an account holder in the account holder group, the server compares the new transaction information to the transaction information in the graph database for the account holder group and determines for the new transaction information a fraud factor indicative of a degree of similarity to the transaction information of the account holder group. The server then transmits a notification based on the fraud factor to at least one of the group consisting of the transaction data processing server. The one of the merchant transaction devices, and an account holder device associated with the account holder.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic representation of a fraud evaluation system according to an embodiment of the invention;

FIG. 2 is a depiction of a transaction data graph;

FIG. 3 is a flow chart of actions in a method according to an embodiment of the invention;

FIG. 4 is a flow chart of actions in a method according to an embodiment of the invention;

FIG. 5 is a flow chart of actions in a method according to an embodiment of the invention; and

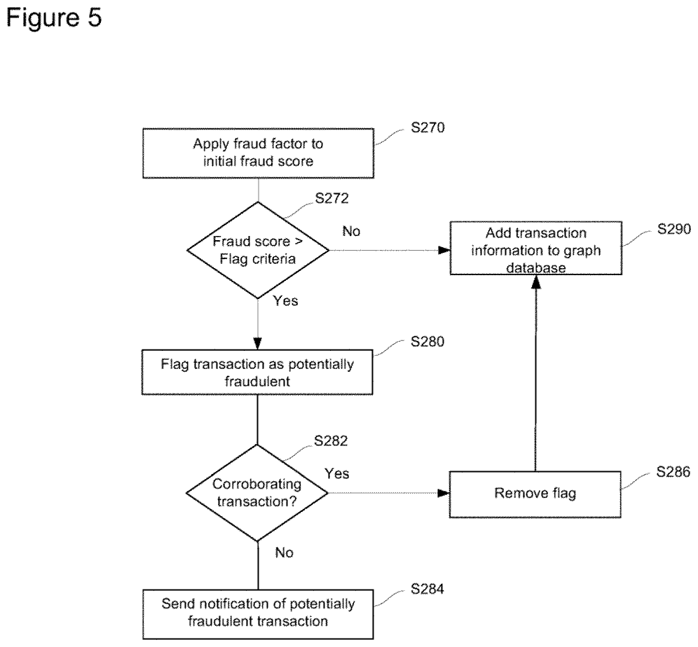

FIG. 6 is a flow chart of actions in a method according to an embodiment of the invention.

### DETAILED DESCRIPTION OF THE INVENTION

While the invention will be described in connection with particular embodiments and manufacturing environments, it will be understood that the invention is not limited to these embodiments and environments. On the contrary, it is contemplated that various alternatives, modifications and equivalents are included within the spirit and scope of the invention as described.

The disclosed embodiments provide a system that evaluates an account holder transaction for fraud by comparing the transaction to transactions of a group of account holders with which the account holder has been associated. Account holder group associations are determined by graphical analysis of previous transaction data. The system groups account holders based on similarities between transaction characteristics. For example, account holders that have a large number of transactions at similar times in a small geographic area or at a single merchant, may be formed into a group. As information on new transactions arrives, the system can conduct fraud evaluation by comparing these transactions with the transactions of the group. Similarity to other group transactions can reduce the likelihood that a new transaction is fraudulent. Using the information from the graph database, the system can either establish a likelihood of fraud or determine a factor that increases or decreases a fraud likelihood based on other factors. The systems and methods described herein may work in real-time, such as at the moment a transaction is attempted using one or more accounts.

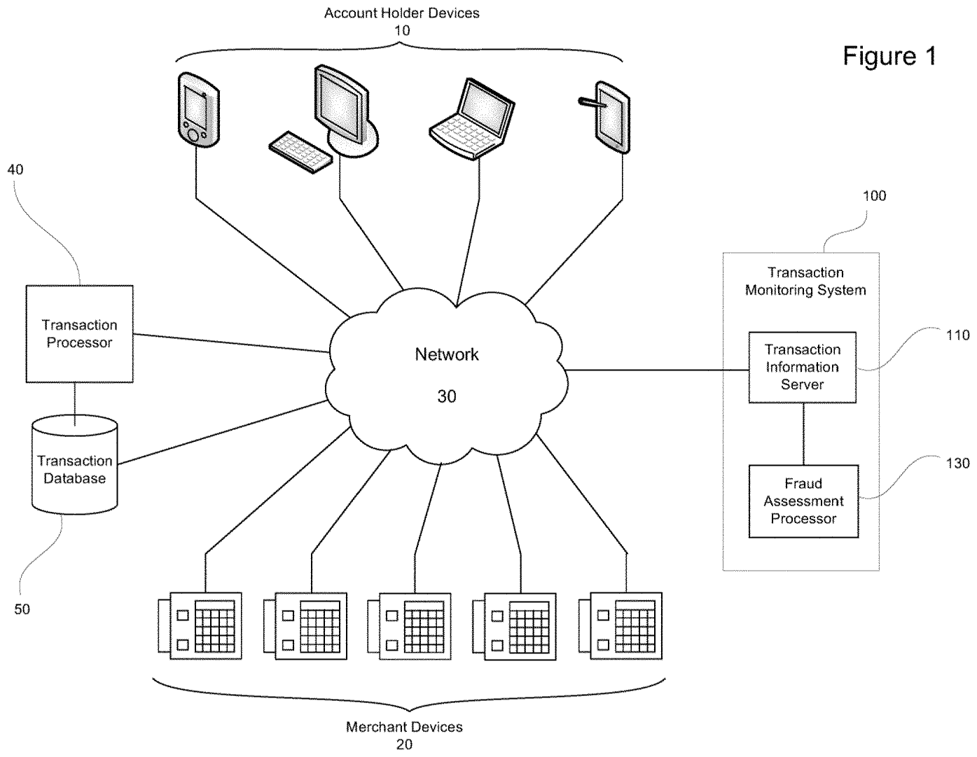

FIG. 1 depicts a transaction monitoring system 100 according to an embodiment of the invention. The system 100 may include various network-enabled computer systems, including, as depicted in FIG. 1 for example, a transaction information server 110 and a fraud assessment processor 130. The transaction information server 110 is in communication with a transaction database 50. The transaction information server 110 may also be in communication with a plurality of account holder devices 10, a plurality of merchant transaction processing devices 20, and/or a transaction processor 40 via network 30 from any of which the transaction information server can receive transaction information. As shown in FIG. 1, communication between the transaction information server 110 and the transaction database 50 may also be via the network 30. Alternatively, the transaction information server 110 and the transaction database 50 may communicate by another local or wide area network. In some embodiments, the transaction processor 40, the transaction database 50 and the transaction monitoring system 100 may be connected by a network separate from the network 30.

As referred to herein, a network-enabled computer system and/or device may include, but is not limited to any computer device, or communications device including, a server, a network appliance, a personal computer (PC), a workstation, and a mobile processing device such as a smart phone, smart pad, handheld PC, or personal digital assistant (PDA). Mobile processing devices may include Near Field Communication (NFC) capabilities, which may allow for communication with other devices by touching them together or bringing them into close proximity.

The network-enabled computer systems used to carry out the transactions contemplated in the embodiments may execute one or more software applications to, for example, receive data as input from an entity accessing the network-enabled computer system, process received data, transmit data over a network, and receive data over a network. The one or more network-enabled computer systems may also include one or more software applications to notify an account holder based on transaction information. It will be understood that the depiction in FIG. 1 is an example only, and the functions and processes described herein may be performed by any number of network-enabled computers. It will also be understood that where the illustrated system 100 may have only a single instance of certain components, multiple instances of these components may be used. The system 100 may also include other devices not depicted in FIG. 1.

In the example embodiments presented herein, an account holder may be any individual or entity that desires to conduct a transaction (which may be, but is not limited to a financial transaction) with a merchant using a transaction account. An account holder device 10 may be a mobile device or other processor that an account holder uses to carry out a transaction. An account may be held by any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. In some instances, the account holder may be a transaction processing entity such as a financial institution, credit card provider, or other entity that offers accounts to customers. An account may or may not have an associated card, such as, for example, a credit card for a credit account or a debit card for a debit account. The account card may be associated or affiliated with a merchant or one or more social networking sites, such as a co-branded credit card.

A transaction account may be associated with a transaction card (e.g., a debit card, credit card, or prepaid account card. Alternatively or in addition, the transaction account may be associated with an account holder processing device or simply associated with a unique identifier enterable by the account holder to facilitate a transaction. The mobile device may be configured to act as a method of payment at a POS location using, for example, NFC or any other mobile payment technology.

A merchant transaction processing device 20 may be any network enabled processor configured for processing a transaction with an account holder. As used herein, a merchant is any entity with which an account holder carries out a transaction. This may include without limitation any retailer, wholesaler, or bartering entity. A merchant may have one or more physical locations or may be an online retailer. The merchant transaction processing device 20 may be any network enabled device (e.g., cash register or other POS terminal or an on-line transaction server) capable of carrying out the transaction and communicating with the transaction processor 40.

The network 30 may be any form of communication network capable of enabling communication between the transaction entities and the transaction monitoring system 100. For example, the network 30 may be one or more of a wireless network, a wired network or any combination of wireless network and wired network. The network 30 may be or include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MIMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal. The network 30 may utilize one or more protocols of one or more network elements to which it is communicatively coupled. The network 30 may translate to or from other protocols to one or more protocols of network devices. Although the network 20 is depicted as a single network, it will be appreciated that it may comprise a plurality of interconnected networks, such as, for example, the Internet, a service provider's network, a cable television network, corporate networks, and home networks.

The transaction database 50 is a relational database configured for storage and retrieval of transaction information associated with a transaction between an account holder and a merchant. Transaction information may be received and stored in the transaction database 50 by the transaction processor 40 or, in some embodiments, by the transaction information server. Information for a transaction may be provided by one or more of the account holder's processing device 10, the merchant's transaction processing device 20, and the transaction processor 40. Transaction information may include any of various aspects of the transaction including an account identifier associated with the account holder's account, a merchant identifier, the subject matter of the transaction, the date and time of the transaction, and an amount of payment. The transaction information may also include location information, such as geographical information associated with the physical location where the transaction was conducted. If the transaction is carried out using an account holder's processing device, the transaction data may include information sufficient to identify the device and/or the location of the device at the time of the transaction. In some cases, the transaction data may include a goods category (e.g., clothing, electronics, restaurant, grocery store, hardware store, etc.).

The fraud assessment processor 130 is configured for receiving transaction information from the transaction database 50 via the transaction information server 110. In some embodiments, transaction information may be received directly from an account holder device 10 or a merchant device 20. The fraud assessment processor 130 is further configured to assemble and processes transaction information from large numbers of transactions for multiple account holders and to use that information to assess the likelihood that an individual transaction is fraudulent. This is accomplished through the construction of a graph database.

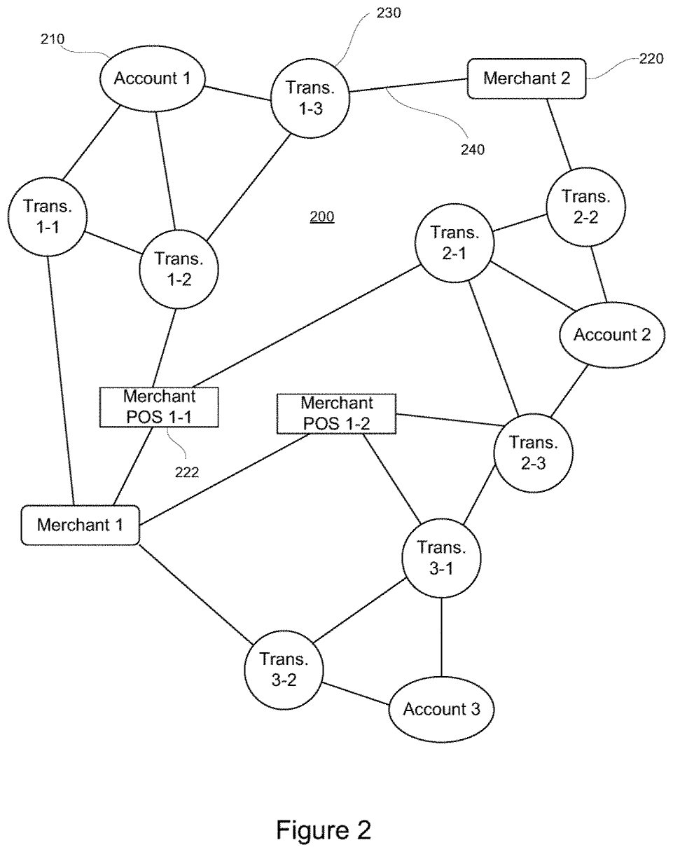

A graph database allows the grouping and analysis of data based on individual data points and the relationships between them. In the graph database, data elements are represented as nodes, while the relationships between the data elements are represented as lines (referred to herein as “edges”) 240 connecting the nodes. With respect to transaction data, nodes may be used to represent any of various elements associated with the transactions. FIG. 2 provides a simplified representation of a transaction data structure 200 involving a series of transactions 230 between a plurality of accounts 210 and a plurality of merchants 220. Each of these items is represented in the graph database as a node. The lines (edges) between these nodes represent the relationship between the connected items. Thus, the line between the Account 1 node and the Transaction 1-3 node is representative of the fact that that Account 1 was a participant in Transaction 1-3. Similarly, the line between the Merchant 2 node and the Transaction 1-3 node is representative of the fact that that Merchant 2 was also a participant in Transaction 1-3. These particular edges indicate that Account 1 and Merchant 2 participated directly with one another (e.g., via an on-line transaction). In contrast, some transactions such as Transactions 1-2 and 2-1 took place at a Merchant POS 222, resulting in an edge between these transaction nodes and Merchant POS 1-1.

The length of the edges 240 connecting certain node pairs may be a mathematical function related to a relationship between the nodes (e.g., a particular transaction parameter). For example, the length of an edge 240 could be a function of the magnitude of the transaction. An edge between transactions could be representative of the difference in magnitude of a particular parameter (e.g., time or distance/location). Any mathematical functions that allow statistical comparison of transaction parameters across a large number of transactions can be used.

Representation of transaction data using graph database structures like that of FIG. 2 allow efficient clustering of nodes based on statistical similarity of their associated relationships. In a simple example, it can readily be seen that certain account holders have a large number of transactions with certain merchants or at certain merchant locations. As additional transaction parameters and relationships are added to the graph database, more complex criteria and algorithms can be used to construct groups that provide a statistically relevant basis for evaluating new transactions associated with group members. More specifically, given enough transaction data, a graph database can be used to identify and cluster the transactions of an account holder group, which can be used to assess whether a new transaction associated with a group member account is potentially fraudulent.

Accordingly, the fraud assessment processor 130 is configured to break down transaction information from the transaction database (or other source(s)) and to construct a graph database in which the nodes represent individual transactions and the edges connecting the nodes represent relationships between the transactions. The fraud assessment processor 130 is further configured to use statistical analysis of the relationships in the graph database to identify and associate account holders having similar transaction characteristics. Such associations can be based on the relative closeness (proximity) of the transactions within the space of the graph. Account holders sharing a predetermined number or percentage of transactions falling within a threshold proximity could be grouped with one another. The threshold proximity could be based on a single relationship parameter or aggregated across multiple parameters. Alternatively, account holder association could be based transaction relationship parameters being within a predetermined multiple of standard deviations from a mean value across all transactions.

It will be understood that the invention is not limited to a particular statistical approach to grouping account holders. Any approach may be used that provides a statistically significant commonality such that an individual transaction associated with one of the grouped account holders may be compared with the set of all transactions of all the grouped account holders.

The fraud assessment processor 130 may update the graph database and the group associations on a periodic or continuous basis. In some embodiments of the invention, the various transactional relationships may be given a weight value that decreases with time so that the effect of newer transactions is greater than that of older transactions. As a result, real changes in circumstances or behavior of account holders are accounted for, which can result in such account holders migrating between groups.

Once the account holders have been grouped, the fraud assessment processor 130 can evaluate the likelihood of fraud in an individual transaction by comparing the transaction to those of a group that includes the transaction's account holder. For example, the position of the transaction in the graph database relative to the transactions of the group's space in the graph database can be used as an indicator of the likelihood that the transaction may be fraudulent. The closer the transaction to a statistical mean of the group (or a portion of the group) the less the likelihood of fraud.

The relative proximity of a transaction to the group can be quantified to establish a graph-based fraud factor. In some embodiments, this factor could be used to raise a flag in relation to the transaction if it fails to meet a threshold value. In other embodiments, it could be used to adjust a fraud value determined by other factors. For example, the fraud assessment processor 130 could be programmed to determine (or to receive a determination from another source) that a transaction is potentially fraudulent if a value for the transaction exceeds a certain threshold and to assign a score indicating a likelihood of fraud. The graph-based fraud factor could be used to raise or lower that score depending on the transaction's degree of commonality with transactions from the account holder's group. If, for example, other members of the account holder's group had similarly sized transactions at around the same time as the challenged transaction, the likelihood of fraud would be lessened. This would be reflected in the graph-based fraud factor, which would lower the fraud score when applied thereto.

The fraud assessment processor 130 may be configured to return an assessment result in the form of an overall fraud assessment score, the graph-based fraud factor, or other fraud score adjustment to the transaction information server 110. Alternatively or in addition, the assessment result can be communicated to the transaction processor 40. In some embodiments, the assessment may be used to determine if an alert should be transmitted to the account holder.

In some alternative embodiments, some or all of the functions of the fraud processor may be resident in the account holder device 10 or the merchant 20. In some such embodiments, these devices are capable of communicating with the transaction database 50 to obtain transaction data and to use the transaction data to construct a graph database, identify an appropriate group for use in assessing a new transaction, and determining a likelihood of fraud. In other embodiments, the graph database may be constructed by a transaction monitoring server 100 and periodically or upon demand downloaded to the account holder device 10 or merchant device 20. An app resident on the account holder device 10 or merchant device 20 could then be used to evaluate a new transaction.

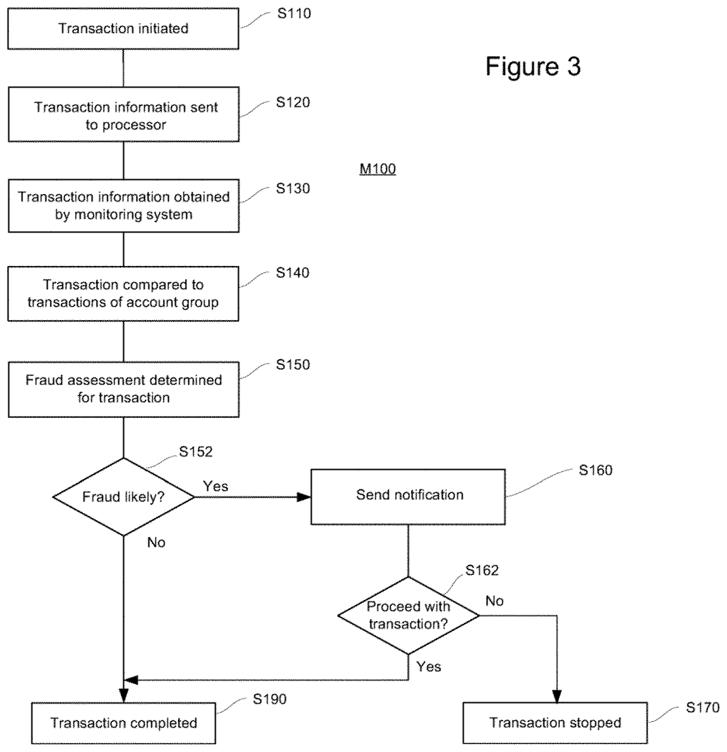

FIG. 3 presents an illustrative method M100 of processing a transaction that incorporates fraud evaluation techniques according to the invention. At S110, a transaction between an account holder and a merchant is initiated. While this transaction will typically be initiated by the account holder, there are some instances where the transaction may be initiated by the merchant. The transaction may be or include any form of bargain between the two parties including any form of trade, purchase or other financial transaction. The transaction may, without limitation, take place on-line or through a POS belonging to or franchised by the merchant. During or after the execution of the transaction, transaction information is sent at S120 to a transaction processor, which in some cases may be or be associated with the merchant. The transaction information may be transmitted to the processor by a merchant terminal, server, or other network-enabled device or by an account holder device. The transaction information may include an account or account holder identifier and one or more additional transaction parameters which may include merchant identifier and/or POS identifier, the subject matter of the transaction, the date and time of the transaction, and an amount of payment. The transaction information may also include geographical location information. The transaction information may be immediately processed and stored in a transaction database. Alternatively or in addition, the transaction information can be obtained by a transaction monitoring server at S130 where the transaction can be assessed by a fraud assessment processor.

At S140, the fraud assessment processor compares the transaction parameters to those of other transactions of the account holder and other members of an account group of which the account holder is a member. As discussed in more detail hereafter, the account group may have been previously determined based on clustering transactions in a graph database. At S150, a fraud assessment is determined for the transaction based on a degree of similarity to other transactions within the account group. Based on this determination, a decision is made at S152 whether the transaction is likely to be fraudulent. If not, no further action is taken and the transaction, if still pending, is completed at S190. In some embodiments, a notification of approval may be sent. If fraud is found to be likely, a notification of such can be sent to one or more of the transaction processor, the account holder, and the merchant at S160. At S162, a decision can be made whether to proceed with the transaction. Depending on the transaction, this decision may be made by the transaction processor, the merchant, or the account holder. In some embodiments, there may be a sequential process by which all three of these entities must approve the transaction before it can be completed. In any case, based on the decision results, the transaction may be stopped at S170 or allowed to complete at S190.

It will be understood that in some embodiments, the transaction will have been completed before the fraud assessment is made. In such embodiments, actions subsequent to a positive fraud determination at S152 may be limited to notifications.

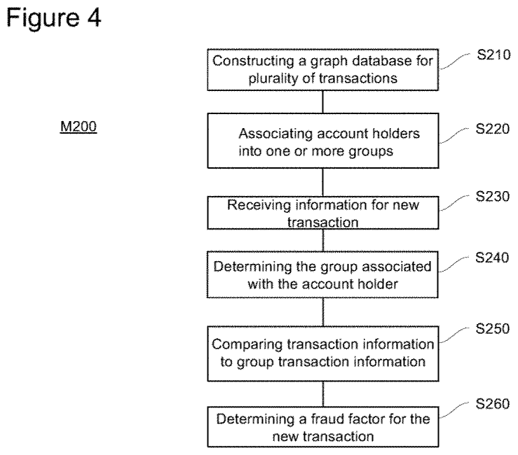

With reference now to FIG. 4, a method M200 of evaluating a transaction for fraud includes at S210, constructing a graph database using transaction information from a plurality of transactions. The information for the graph database is drawn from a relational database in which transaction information has been stored for the plurality of transaction. Information for each transaction includes an identifier associated with the account holder and other information associated with the transaction. The graph database is constructed by breaking down the transaction information for multiple transactions according to qualitative relationships based on such data as the account holder and merchant involved in the transaction and the type of goods purchased, and quantifiable relationships, which may be based on such parameters as the transaction date and time, transaction location, and a value amount for the transaction. The length of an edge representing a quantifiable relationship between two nodes represents the degree of closeness (i.e., proximity) of the nodes with respect to a particular transaction parameter. For example, the transaction dates and times for two transactions can be used to determine the time interval between the two transactions (i.e., their temporal spacing), the relative size of which can be represented as an edge length. Similarly, transaction locations can be used to determine physical spacing, the relative magnitude of which can also be represented as an edge length.

At S220, the graph database is used to associate account holders into one or more groups. As discussed above, this is accomplished based on criteria relating to the relative closeness of account holder transactions with respect to one or more transaction characteristics. Statistical analysis can be used to find mean and standard deviations of edge length across all transactions to identify patterns and inter-relationships. Account holders found to have a degree of similarity or “closeness” are associated as a group. It will be understood that the larger the number of transactions in the graph database, the higher the confidence in the group association.

It will be understood that multiple statistically relevant groups may be formed from a single graph database, and that, in some embodiments, account holders may be associated into more than one group.

At S230, transaction information for a new transaction is received. As before, the transaction information includes an account identifier or account holder identifier and information on one or more transaction parameters. At S240, the transaction information is used to determine the group the account holder is associated with, if any. Once the group is determined, the new transaction information can be compared at S250 to the information previously associated with that group. The comparison can be made by placing the transaction within the space of the graph database and using statistics to determine its relative closeness to the other transactions in that space. Alternatively or in addition, the transaction can be evaluated against each transaction to determine if it is close enough to a particular transaction so as to indicate a link. At S260, a numerical factor is determined that represents the relative closeness or statistical similarity of the new transaction to the previous transactions of the group. This factor, which may be referred to as a fraud factor, is essentially an indicator of degree to which the new transaction jibes with historical behavior of the members of the account holder's group.

In some embodiments, the fraud factor can, itself, be taken as an indicator of the relative likelihood of fraud. For example, if the transaction is so far outside the normal space of the group's transactions, the fraud factor could exceed a predetermined threshold level. In response, the system could apply a flag to the transaction and send out a notification that the transaction is potentially fraudulent.

In other embodiments, the fraud factor can be used to raise or lower an initial fraud score established using other methods. If, for example, the transaction has been assigned a high likelihood of fraud, the methods of the invention provide for the adjustment of this score based on the similarity of the transaction to other transactions in the group. In one approach, the fraud factor could be computed as a multiplier that is less than one if the transaction is highly typical of the group and is greater than one if the transaction is highly atypical. Application of the fraud factor would decrease the fraud score in the former case and increase it in the latter.

FIG. 4 illustrates an optional continuation of the method M200 that incorporates the above approach. At S270, the fraud factor is applied to the initial fraud score as an adjustment. At S272, the fraud score is compared to threshold criteria for flagging the transaction. If the score falls above the threshold, the transaction is flagged as potentially fraudulent at S280 and a notification transmitted at S284. As will be discussed in more detail below, some embodiments may optionally include an additional check at S282. In this variation, the system can look to see if there are one or more transactions (referred to herein as corroborating transactions) within the group that are so close to the new transaction (e.g., in time, location, and transaction value) that fraud is unlikely, regardless of the statistical analysis. If such corroborating transactions are found, the flag can be removed at S286. In both this scenario and in the case where the fraud score falls below the flag criteria, the transaction information can optionally be added to the graph database.

While statistical analysis can be used to identify transactions that do not appear to fit the typical profile a of an account holder or account group, such transaction are not always fraudulent. Indeed, many, if not most, account holders are likely to have an occasional transaction that falls outside the normal statistical boundary of their group. For example, an account holder who typically uses an employer-issued credit card for relatively small, local expenses may purchase a non-refundable airline ticket and incur distant travel-related expenses, all of which result in statistics-based flagging as potentially fraudulent charges.

Aspects of the disclosed embodiments can be used to cut back on unnecessary flagging of legitimate transactions such as those described above. This may be accomplished by reaching beyond the overall statistical approach, and running an additional check to see if others members of the account holder's account group had similar isolated transactions in terms of subject matter, magnitude and timing. To continue with the example above, because of commonality of usage and transaction characteristics, the transaction monitoring system would likely place the employee account holder in the same account group as other employees of the his or her company. If one or more of these group members accompanied the account holder on the trip as part of a company initiative, the group member(s) would likely have similar transactions to the account holder. These transactions can be said to “corroborate” the validity of challenged transaction of the account holder.

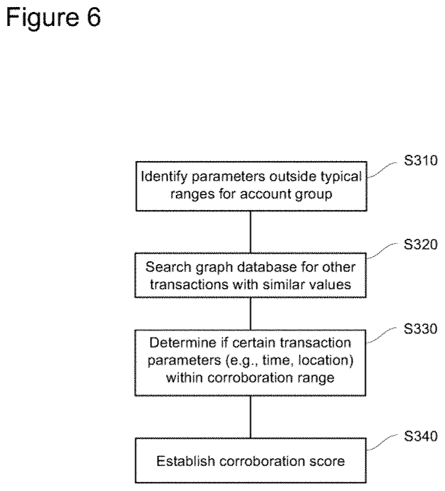

With reference to FIG. 6, a method M300 of corroborating a transaction includes at S310 identifying for the challenged transaction, those parameters that are outside typical ranges (e.g., outside 2σ from the mean) for the account holder group. At S320, the transactions of the account holder group are reviewed to identify other transactions that have similar outlying values for these parameters. At S330, other parameters for these transactions are compared to those of the challenged transaction to see if there is a likelihood that there is a real world connection between the transactions. For example, if the challenged transaction has been flagged because of a high transaction value and two other transactions within the account group have similar transaction values, the date, time, location and merchant for the two transaction may be compared to those of the challenged transaction. The degree of closeness of these parameters can be used to determine a corroboration score at S340. If the comparison transaction parameters are very close to those of the challenged transaction, the corroboration score would be high. Thus, if in the above example, the two comparison transactions were conducted at nearly the same time at the same location, there is a high likelihood that all three of the transactions are authentic, despite the fact that they are outside the statistical thresholds of the account group. Accordingly, the corroboration score for the challenged transaction would be high, indicating that its fraud score could be reduced and/or any flag for potential fraud could be removed. Corroboration score may be a function of the degree of closeness between transaction parameters and the number of transactions having relatively near transaction parameters.

The disclosed embodiments provide a significant improvement to existing fraud detection systems and methods in that it may reduce the number of unnecessary notifications of potentially fraudulent activity. This, in turn, may result in significant cost and time savings to account holders, merchants, and transaction processors. The embodiments also allow resources dedicated to fraud response to be focused on transactions that are more likely to involve actual fraud.

It will be readily understood by those persons skilled in the art that the embodiments are susceptible to broad utility and application. Many embodiments and adaptations of the present invention other than those herein described, as well as many variations, modifications and equivalent arrangements, will be apparent from or reasonably suggested by the disclosed embodiments and foregoing description thereof, without departing from the substance or scope of the invention.

1. A fraud evaluation system comprising:
a server in data communication with a transaction database comprising transaction information for a plurality of transactions, the transaction information for each transaction including an account holder identifier and at least one transaction parameter; and
an automated data processor in data communication with the server, the data processor being configured to:
construct a graph database of transaction relationships using the transaction information for the plurality of transactions, the graph database including a node for each transaction parameter of each of the plurality of transactions and an edge between all pairs of related nodes, each such edge representing a transaction relationship between node transaction parameters,
associate a plurality of account holder identifiers into an account holder group using the graph database to determine statistical similarities across transaction parameters and relationships for the plurality of account holders,
receive transaction information for a new transaction associated with an account holder in the account holder group,
compare the new transaction information to the transaction information in the graph database for the account holder group by positioning the new transaction in the graph database for the account holder group,
determine for the new transaction information from the relative positioning of new transaction nodes in the graph database for the account holder group, a fraud factor indicative of a degree of statistical similarity of the new transaction to the transaction information of the account holder group,
compare the fraud factor to a predetermined fraud threshold, and
responsive to a determination that the fraud factor exceeds the fraud threshold, halt processing of the new transaction.

2. The fraud evaluation system of claim 1, wherein the at least one transaction parameter includes at least one of the set consisting of a transaction location, a transaction time, a transaction vendor, a purchase type, and a purchase amount.

3. The fraud evaluation system of claim 1, wherein the transaction relationships are based on or include at least one from the set consisting of difference in time between transactions, relative location of transactions, difference in transaction value, relationship of merchants involved in transactions, and similarity of transaction subject matter.

4. The fraud evaluation system of claim 1, wherein the account holder group includes only account holder identifiers associated with transactions parameters falling within a predetermined proximity of one another within the graph database.

5. The fraud evaluation system of claim 2, wherein the automated data processor is configured to associate account holder identifiers into an account holder group based on statistical proximity of account holder transactions with respect to at least one transaction parameter.

6. The fraud evaluation system of claim 1, wherein the automated data processor is further configured to:
responsive to a determination that the fraud factor exceeds the fraud threshold, associate a fraud designation flag with the new transaction and transmit a notification to a client device associated with the account holder identifier for the new transaction.

7. The fraud evaluation system of claim 1, wherein the automated data processor is further configured to:
apply the fraud factor to a fraud score associated with the transaction to determine an updated fraud score,
compare the updated fraud score to a predetermined fraud threshold, and
responsive to a determination that the fraud score exceeds the fraud threshold, associate a fraud designation flag with the new transaction and transmit a notification to a client device associated with the account holder identifier for the new transaction.

8. The fraud evaluation system of claim 1, wherein the transaction database receives new transaction information from a merchant device.

9. A method for detecting fraud comprising:
constructing a graph database of transaction relationships using transaction information for a plurality of transactions, the transaction information including, for each transaction, an account holder identifier and at least one transaction parameter selected from the group consisting of a transaction location, a transaction time, a transaction vendor, a purchase type, and a purchase amount, and the graph database including a node for each transaction parameter of each of the plurality of transactions and an edge between all pairs of related nodes, each such edge representing a transaction relationship between node transaction parameters;
associating a plurality of account holder identifiers into an account holder group using the graph database to determine statistical similarities across transaction parameters and relationships for the plurality of account holders;
receiving, by a transaction monitoring server from one of the set consisting of a merchant terminal, merchant server, and an account holder device, transaction information for a new transaction between a merchant and an account holder associated with a transaction account holder identifier, the transaction being processed by a transaction processor;
determining, by the transaction monitoring server, whether the transaction account holder identifier is included in the account holder group;
responsive to a determination that the transaction account holder identifier is included in the account holder group, the transaction monitoring server
using the new transaction information to position the new transaction in the graph database for the account holder group,
determining for the new transaction from the relative positioning of new transaction nodes in the graph database for the account holder group, a fraud factor indicative of a degree of statistical similarity of the new transaction to the transaction information of the account holder group,
comparing the fraud factor to a predetermined fraud threshold, and
responsive to a determination that the fraud factor exceeds the fraud threshold, transmitting, to the transaction processor, an instruction to halt the new transaction.

10. The method for detecting fraud of claim 9 wherein, responsive to determination that the fraud factor exceeds the fraud threshold, the method further includes:
associating a fraud designation flag with the new transaction, and
sending a notification to a client device associated with the transaction account holder identifier.

11. The method for detecting fraud of claim 10 wherein, responsive to determination that the transaction account holder identifier is included in the account holder group, the method further includes:
applying the fraud factor to a fraud score associated with the transaction to determine an updated fraud score,
comparing the updated fraud score to a predetermined fraud threshold, and
responsive to a determination that the fraud score exceeds the fraud threshold, associating a fraud designation flag with the new transaction and transmitting a notification to a client device associated with the account holder identifier for the new transaction.

12. The method for detecting fraud of claim 10, wherein, responsive to determination that the transaction account holder identifier is included in the account holder group, the method further includes:
identifying a corroborating transaction in the transactions of the account holder group; and
adjusting at least one of the set consisting of the fraud factor and a fraud score based on the corroborating transaction.

13. The method for detecting fraud of claim 10, wherein constructing the graph database comprises:
creating a node for each of the plurality of transactions and associating the node with the at least one transaction parameter for the transaction;
connecting each node to at least one other node by an edge having a length representing a transaction parameter relationship between the transactions represented by the connected nodes.

14. The method for detecting fraud of claim 13, wherein the transaction parameter relationship is based on differences in one or more corresponding transaction parameters for the connected nodes.

15. The method for detecting fraud of claim 13, wherein associating a plurality of account holder identifiers into a an account holder group comprises:
identifying all nodes within a predetermined statistical proximity of one another with respect to one or more transaction parameters,
determining the account holder identifiers associated with the nodes within the predetermined statistical proximity, and
associating the determined account holder identifiers into the account holder group.

16. The method for detecting fraud of claim 15, wherein identifying all nodes within a predetermined statistical proximity of one another includes determining the mean and standard deviation of all edge lengths associated with the one or more transaction parameters.

17. The method for detecting fraud of claim 13, wherein comparing the new transaction information to the transaction information in the graph database includes;
positioning a new transaction node in the graph database based on the new transaction information, and
determining edge relationships between the new transaction node and the nodes associated with the account holder group.

18. The method for detecting fraud of claim 17, wherein comparing the new transaction information to the transaction information in the graph database further includes;
determining whether the new transaction node falls within the predetermined statistical proximity with respect to the one or more transaction parameters.

19. A transaction processing system comprising:
a transaction database configured for receiving transaction information associated with a plurality of transactions initiated at merchant transaction devices from the transaction data processing server and for storage of the transaction information for transactions associated with a plurality of account holders the transaction information including for each transaction, an account holder identifier and at least one transaction parameter; and
a transaction monitoring server in data communication with the transaction database, the transaction monitoring server being configured to:
receive transaction information for the plurality of transactions from the transaction database,
construct a graph database of transaction relationships using the transaction information for the plurality of transactions,
associate a plurality of account holder identifiers into an account holder group based on a statistical transaction similarity determined using the graph database, and
upon receiving transaction information from a merchant transaction device for a new transaction associated with an account holder in the account holder group,
compare the new transaction information to the transaction information in the graph database for the account holder group,
determine for the new transaction information a fraud factor indicative of a degree of similarity to the transaction information of the account holder group,
determine, based on the fraud factor, whether the transaction should be continued or terminated, and
responsive to a determination that the transaction should be terminated, transmit a termination notification to at least one of the group consisting of a transaction processing server, the merchant transaction device, and an account holder device associated with the account holder.

20. The transaction processing system of claim 19 wherein the termination notification includes the fraud factor.
